(19) United States
(12) Patent Application Publication
(10) Pub. No.: US 2026/0186456 A1
(43) Pub. Date: Jul. 2, 2026

(54) SYSTEMS AND METHODS FOR TESTING ADVANCED PROCESS CONTROL (APC) STRATEGIES IN A FACILITY

(71) Applicant: Honeywell International Inc., Charlotte, NC (US)

(72) Inventors: Peter John William Hart, KELLS MEATH (IE); Mandar Vartak, Bangalore (IN); Vinay Narasimhamurthy, Bangalore (IN); Kiran Raviprakash, Bangalore (IN); Kundan Kumar, Bangalore (IN); Satheesh Kumar G, Bangalore (IN)

(21) Appl. No.: 19/007,605

(22) Filed: Jan. 2, 2025

(51) Int. Cl. G05B 13/04

(52) U.S. Cl. CPC G05B 13/048

(57) ABSTRACT

Various embodiments described herein relate to systems and methods for testing Advanced Process Control (APC) strategies in a facility. In this regard, snapshots of a model predictive controller which is under operation in the facility is captured. Using the snapshots, a digital twin of a process unit is initialized. Then, a tuning overlay is rendered via a user interface. Further, inputs from a user via the user interface is received for fields in the tuning overlay. The inputs are associated with at least one APC strategy that is to be tested for the process unit. Based on the inputs, the at least one APC strategy is tested using the digital twin of the process unit. In response to the testing, results for the at least one APC strategy are rendered on the user interface. Also, based on the results, at least one operation of the process unit is modified.

### TECHNICAL FIELD

The present disclosure generally relates to industrial process control and automation systems. More particularly, the present disclosure relates to testing one or more advanced process control (APC) strategies in a facility.

### BACKGROUND

Generally, a facility (such as an industrial plant, a manufacturing unit, a processing factory, and/or the like) includes numerous assets or equipment such as boilers, chillers, pumps, sensors, air handling units (AHUs), variable refrigerant flow (VRF) systems, blenders, furnaces, and/or the like. Often these assets are employed to facilitate various processes in the facility. For instance, a specific set of assets may operate to facilitate certain processes such as blending operations to produce say, petroleum products from crude oil. Accordingly, numerous such processes are undertaken on a day-to-day basis using the assets employed in the facility. Given that the number of assets along with the processes are quite substantial, manually managing all of the assets and the processes by personnel associated with the facility becomes an error-prone chore and a challenging task. So, the facility often adopts automated solutions such as advanced process control (APC) techniques to manage such assets and processes. That is, the APC techniques incorporate several models such as multivariable models with regards to managing (that is, controlling and optimizing) various assets and diverse processes in the facility. In this regard, the facility may also use the APC techniques to test various scenarios as well. However, such APC techniques have some drawbacks with regards to testing operations. For example, when an APC application is controlling an asset which is under operation or a live process, changes made to a model of the APC application may not be supported as it may negatively affect the operation of the asset or the live process along with overall performance of the facility as well. In another example, performing a testing operation using an APC application when online may result in a writing out situation where values from a live process may be lost or a state of an asset which is under operation may not be captured. With this, testing out various scenarios using APC techniques becomes an arduous task for the facility.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 illustrates a schematic diagram showing an implementation of an exemplary process control system, in accordance with one or more example embodiments described herein.

FIG. 2 illustrates a schematic diagram showing an implementation of an exemplary device that may execute techniques, in accordance with one or more example embodiments described herein.

FIG. 3 illustrates a schematic diagram showing an implementation of an exemplary cascaded model predictive control (MPC) system for an exemplary process control system, in accordance with one or more example embodiments described herein.

FIG. 4 illustrates a schematic diagram showing an implementation of an exemplary testing environment, in accordance with one or more example embodiments described herein.

FIG. 5 illustrates a schematic diagram showing a specific implementation of an exemplary process associated with an exemplary testing environment, in accordance with one or more example embodiments described herein.

FIG. 6 illustrates a schematic diagram showing an exemplary user interface associated with an exemplary testing environment, in accordance with one or more example embodiments described herein.

FIG. 7 illustrates a schematic diagram showing an exemplary user interface associated with an exemplary testing environment, in accordance with one or more example embodiments described herein.

FIG. 8 illustrates a schematic diagram showing an exemplary user interface associated with an exemplary testing environment, in accordance with one or more example embodiments described herein.

FIG. 9 illustrates a flowchart showing a method described in accordance with one or more example embodiments described herein.

FIG. 10 illustrates a flowchart showing a method described in accordance with one or more example embodiments described herein.

FIG. 11 illustrates a flowchart showing a method described in accordance with one or more example embodiments described herein.

### SUMMARY

The details of some embodiments of the subject matter described in this specification are set forth in the accompanying drawings and the description below. Other features, aspects, and advantages of the subject matter will become apparent from the description, the drawings, and the claims.

In accordance with one or more example embodiments of the current disclosure, a method for testing one or more Advanced Process Control (APC) strategies in a facility is described herein. In this regard, the method comprises capturing one or more snapshots of a model predictive controller which is under operation in the facility. Then, the method comprises initializing a digital twin of a process unit using the one or more snapshots of the model predictive controller. Further, the method comprises rendering a tuning overlay via a user interface based on the initialization of the digital twin. Furthermore, the method comprises receiving one or more inputs from a user via the user interface for one or more fields in the tuning overlay. The one or more inputs are associated with at least one APC strategy that is to be tested for the process unit. The method then comprises testing the at least one APC strategy based on the one or more inputs using the digital twin of the process unit. Also, the method comprises rendering one or more results for the at least one APC strategy in response to the testing. Additionally, the method also comprises modifying at least one operation of the process unit based at least on the one or more results.

In accordance with another embodiment of the current disclosure, a system for testing one or more Advanced Process Control (APC) strategies in a facility is described herein. The system comprises a processor and a memory communicatively coupled to the processor, wherein the memory comprises one or more instructions which when executed by the processor, cause the processor to capture one or more snapshots of a model predictive controller which is under operation in the facility. The processor is also configured to initialize a digital twin of a process unit using the one or more snapshots of the model predictive controller. Also, the processor is configured to render a tuning overlay via a user interface based on the initialization of the digital twin. Then, the processor is also configured to receive one or more inputs from a user via the user interface for one or more fields in the tuning overlay. The one or more inputs are associated with at least one APC strategy that is to be tested for the process unit. Further, the processor is configured to test the at least one APC strategy based on the one or more inputs using the digital twin of the process unit. Furthermore, the processor is configured to render one or more results for the at least one APC strategy in response to the testing. Additionally, the processor is also configured to modify at least one operation of the process unit based at least on the one or more results.

In accordance with yet another embodiment of the current disclosure, a non-transitory, computer-readable storage medium having instructions stored thereon and executable by one or more processors is described herein. In this regard, the instructions when executed by one or more processors cause the one or more processors to capture one or more snapshots of a model predictive controller which is under operation in the facility. The one or more processors are also configured to initialize a digital twin of a process unit using the one or more snapshots of the model predictive controller. Also, the one or more processors are configured to render a tuning overlay via a user interface based on the initialization of the digital twin. Then, the one or more processors are also configured to receive one or more inputs from a user via the user interface for one or more fields in the tuning overlay. The one or more inputs are associated with at least one APC strategy that is to be tested for the process unit. Further, the one or more processors are configured to test the at least one APC strategy based on the one or more inputs using the digital twin of the process unit. Furthermore, the one or more processors are configured to render one or more results for the at least one APC strategy in response to the testing. Additionally, the one or more processors are also configured to modify at least one operation of the process unit based at least on the one or more results.

The above summary is provided merely for purposes of providing an overview of one or more exemplary embodiments described herein so as to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which are further explained in the following description and its accompanying drawings.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### DETAILED DESCRIPTION OF THE DRAWINGS

Reference will now be made in detail to embodiments, examples of which are illustrated in the accompanying drawings. In the following detailed description, numerous specific details are set forth in order to provide a thorough understanding of the various described example embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments. The term “or” is used herein in both the alternative and conjunctive sense, unless otherwise indicated. The terms “illustrative,” “example,” and “exemplary” are used to be examples with no indication of quality level. Like numbers refer to like elements throughout.

The phrases “in an embodiment,” “in one embodiment,” “according to one embodiment,” and the like generally mean that the particular feature, structure, or characteristic following the phrase can be included in at least one example embodiment of the present disclosure, and can be included in more than one example embodiment of the present disclosure (importantly, such phrases do not necessarily refer to the same example embodiment).

The word “exemplary” is used herein to mean “serving as an example, instance, or illustration.” Any implementation described herein as “exemplary” is not necessarily to be construed as preferred or advantageous over other implementations. If the specification states a component or feature “can,” “may,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature can be optionally included in some example embodiments, or it can be excluded.

More particularly, industrial process control and automation systems such as advanced process control (APC) techniques are becoming prominent in managing assets and automating complex industrial processes. The APC techniques comprise models such as multivariable models which are customizable per one or more requirements as desired by a facility. Additionally, the APC techniques provide a whole wide range of features to efficiently manage (that is, control and optimize) assets and processes. For instance, the APC techniques using multivariable models predict effects of changing multiple inputs on multiple outputs. That is, the APC techniques drive several processes in the facility through a set of variables to facilitate accurate predictions and undertaking of pre-emptive action to maintain the processes within constraints. Also, the APC techniques provide simulation capabilities that allow personnel to run different simulations for testing various scenarios so as to make tuning and operational decisions based on results of these simulations. However, the simulation capabilities offered by the APC techniques has associated challenges. Firstly, the simulation capabilities provide several simulation blocks which have to be manually set up by an operator. This involves several manual steps such as making checkpoints of existing APC applications, copying them to another server, switching them to simulation, and updating read values (of which there may be hundreds or thousands) based on current operating conditions. Manually setting up the simulation blocks and thereby a digital twin in a simulation environment requires significant time and efforts from the operator. Also, such manual work is often error prone as the set-up of the simulation is completely dependent on skills of the operator and may be frequently subjected to finger trouble at some point or at some steps. With this, an ideal digital twin is never created leading to erroneous simulation results. Secondly, a writing out situation may occur while performing testing using simulation capabilities when an APC application is online. That is, a current state of an asset or a process may be lost since such simulations often require re-initialization which eventually impacts normal operation of an asset or a process. Thirdly, results from each of the said simulations must be manually logged and then compared to other cases. So, the aforementioned challenges inhibit optimal scenario analyses and troubleshooting of APC applications which eventually hampers normal operations of assets and complex industrial processes in the facility.

Thus, to address the above challenges, various examples of systems and methods described herein facilitate testing of Advanced Process Control (APC) strategies in a facility. In this regard, for instance, the system described herein allows personnel such as plant operators and/or APC engineers to test various APC strategies using digital twin of process units in the facility and/or digital twin of the facility itself in an offline environment. Per this aspect, the system described herein allows personnel to perform simplified offline what-if analysis for different test scenarios without affecting functions of APC applications when online. In view of testing the APC strategies, the system is initially configured to capture one or more snapshots of a model predictive controller which is under operation (or live) in the facility. The model predictive controller is often configured to manage a set of assets such as process units (or equipment) along with associated processes handled by the set of assets in the facility. It is to be noted that the system described herein may provide an option on a user interface to capture the one or more snapshots. So, in response to a user such as an operator selecting the option, the system may automatically capture the one or more snapshots of the model predictive controller which is operating in the facility. Then, the system initializes say, a digital twin of a process unit using the one or more snapshots of the model predictive controller. In this regard, the system may load the one or more snapshots into the digital twin to create one or more initial conditions for the digital twin. This is done using current operating conditions and one or more APC checkpoints for the process unit derived from the one or more snapshots. Also, it is to be noted that the system may initialize a digital twin of the facility using the one or more snapshots as well in some instances.

Based on the initialization of the digital twin of the process unit, the system is configured to render a tuning overlay via the user interface. The tuning overlay comprises one or more fields that are included considering the current operating conditions and the one or more APC checkpoints say, for the process unit. Also, the one or more fields in the tuning overlay facilitate the user to provide one or more inputs via the user interface. The one or more inputs are associated with at least one APC strategy that is to be tested for the process unit and/or the facility. In this regard, the at least one APC strategy may be, but not limited to studying change in operating states driven by market or process or environmental conditions or conditions in the facility, economic changes based on change in pricing or availability of raw materials, economic changes due to change in product pricing (for instance, selling price) or demand, and economic changes due to change in availability or cost of utilities, benefit estimation or economic value of implementation of specific process or specific APC strategy, and testing, commissioning and troubleshooting of potential operational issues associated with the assets and/or the processes in the facility. Often, the user provides the one or more inputs in the tuning overlay to modify the current operating conditions and the one or more APC checkpoints for the process unit in view of such at least one strategy that is to be tested. Also, the user may modify certain fields associated with modal plans and/or demand plans for testing the at least one strategy. For example, if the user desires to test and understand change in raw material fed to a blender in view of studying economic benefit, the user may change a feed value in the tuning overlay for the raw material as a part of APC strategy which corresponds to benefit estimation. Similarly, the user may provide changes in the one or more fields of the tuning overlay to test the at least one APC strategy.

Based on the one or more inputs, the system described herein then tests the at least one APC strategy using the digital twin of the process unit. In this regard, the system tests the at least one strategy considering the one or more inputs using the digital twin in an offline environment. That is, the system described herein breaks all communications to distributed control system (DCS)/programmable logic controller (PLC) to ensure that strategies tested do not hamper live operations of the assets and/or the processes in the facility. This also mitigates risks associated with writing out scenario in the facility which is operational or live. Further, the system renders one or more results for the at least one APC strategy on the user interface in response to the testing. The one or more results comprise information desired by the user for the at least one APC strategy. In view of this, the one or more results often comprise difference(s) between a current strategy that is followed in the facility and the at least one strategy that is tested, one or more corrective actions that may be implemented in the facility, one or more significant opportunities that may be utilized in the facility, and one or more predictions related to the assets and/or the processes in the facility. It is to be noted that at least some results may be presented using one or more graphical representations. Also, the system described herein may render the one or more inputs provided by the user via the user interface as graphical representations along with the one or more results as well. It is also to be noted that the system also stores results obtained in response to testing each of APC strategies. The system also allows the user to view and compare results from different strategies via the user interface as well. It is to be appreciated that the system may also use the digital twin of the facility to test the at least one APC strategy as well.

Additionally, the system modifies at least one operation of the process unit based at least on the one or more results. In this regard, for instance, the system may modify an operating point for the process unit, push a process handled by the process unit to an optimal point, and/or the like. It is to be noted that the system may automatically modify the at least one operation of the process unit in some examples whereas the system may modify the at least one operation of the process unit based on one or more additional inputs from the user. The one or more additional inputs may be provided by the user via the user interface in view of the one or more results presented on the user interface upon performing testing of the at least one strategy. The one or more additional inputs may comprise feedback regarding the one or more results and/or one or more user suggested operational changes. Also, the system described herein may create one or more service cases in view of the one or more results.

Accordingly, the system described herein facilitates automatic initialization of digital twins using snapshots of live controller thereby reducing significant time and efforts of personnel in the facility. This also mitigates significant errors that may be caused due to manual work from personnel. Also, the system eliminates risks associated with writing out scenario in the facility as the system enables testing of various scenarios in an offline platform. The results from the testing of various strategies enables strategic planners and engineers associated with the facility to look into the future, by taking a current view of the process unit (and/or the facility) and superimposing likely scenarios on top of this. This will assist in making strategic decisions for managing the assets and/or the processes in the facility at lower operational costs and increased productivity. Additionally, the system facilitates development of an overall robust control system that facilitates better performance and reduced maintenance efforts in the facility.

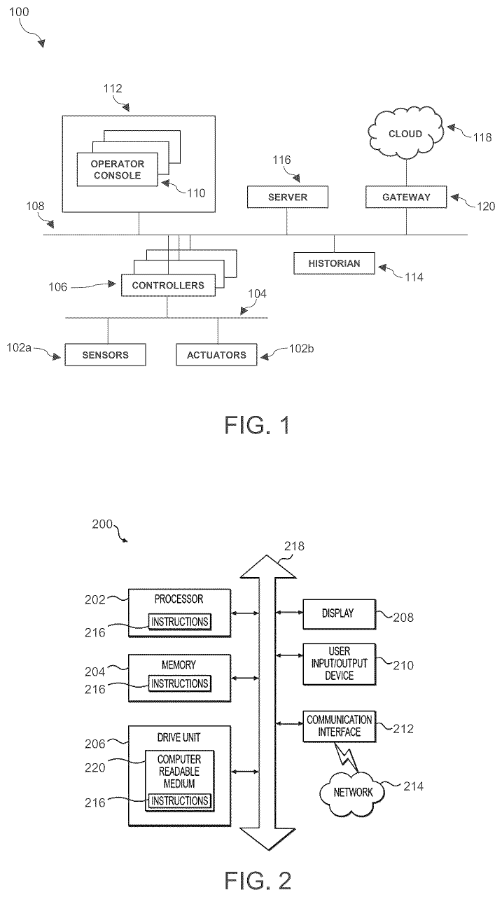

FIG. 1 illustrates a schematic diagram showing an implementation of an exemplary process control system, in accordance with one or more example embodiments described herein. As shown in FIG. 1, the process control system 100 includes various components that facilitate production or processing of at least one product or other material. That is, the process control system 100 may be used to facilitate control over one or more assets in a facility of one or more facilities. The facility may correspond to an industrial plant, a manufacturing unit, a processing factory, and/or the like for instance, that produces at least one product or other material. In general, the facility may implement one or more industrial processes (alternatively, referred to as one or more processes) and may be individually or collectively be referred to as a process system. The process system generally represents any system or portion thereof configured to perform the one or more processes in the facility such as production of one or more products or other materials in some manner.

In FIG. 1, the process control system 100 includes one or more sensors 102a and one or more actuators 102b. The sensors 102a and actuators 102b represent components in the process control system 100 that may perform any of a wide variety of functions. For example, the sensors 102a could measure a wide variety of characteristics in the process control system 100, such as flow, pressure, or temperature. Also, the actuators 102b could alter a wide variety of characteristics in the process control system 100, such as valve openings. Each of the sensors 102a includes any suitable structure for measuring one or more characteristics in the process control system 100. Each of the actuators 102b includes any suitable structure for operating on or affecting one or more conditions in the process control system 100.

At least one network 104 is coupled to the sensors 102a and actuators 102b. The network 104 facilitates interaction with the sensors 102a and actuators 102b. For example, the network 104 could transport measurement data from the sensors 102a and provide control signals to the actuators 102b. The network 104 could represent any suitable network or combination of networks. As particular examples, the network 104 could represent at least one Ethernet network (such as one supporting a FOUNDATION FIELDBUS protocol), electrical signal network (such as a HART network), pneumatic control signal network, or any other or additional type(s) of network(s).

The process control system 100 also includes various controllers 106. The controllers 106 can be used in the process control system 100 to perform various functions in order to control one or more industrial processes. For example, a first set of controllers 106 may use measurements from one or more sensors 102a to control the operation of one or more actuators 102b. A second set of controllers 106 could be used to optimize the control logic or other operations performed by the first set of controllers. A third set of controllers 106 could be used to perform additional functions. The controllers 106 could therefore support a combination of approaches, such as regulatory control, advanced regulatory control, supervisory control, and advanced process control.

Each controller 106 includes any suitable structure for controlling one or more aspects of an industrial process. At least some of the controllers 106 could, for example, represent proportional-integral-derivative (PID) controllers or multivariable controllers, such as controllers implementing model predictive control (MPC) or other advanced predictive control (APC) that may be used to control different assets such as process units in the facility. As a particular example, each controller 106 could represent a computing device running a real-time operating system, a WINDOWS operating system, or other operating system.

At least one of the controllers 106 shown in FIG. 1 denotes a model-based controller that operates using one or more process models. For example, each of these controllers 106 could operate using one or more process models to determine, based on measurements from one or more sensors 102a, how to adjust one or more actuators 102b. In some embodiments, each model associates one or more manipulated or disturbance variables (often referred to as independent variables) with one or more controlled variables (often referred to as dependent variables). Each of these controllers 106 could use an objective function to identify how to adjust its manipulated variables in order to push its controlled variables to be at or near the boundaries of a normal operating envelope. At least one network 108 couples the controllers 106 and other devices (or components) in the process control system 100. The network 108 facilitates the transport of information between components. The network 108 could represent any suitable network or combination of networks. As particular examples, the network 108 could represent at least one Ethernet network.

Operator access to and interaction with the controllers 106 and other components of the process control system 100 can occur via various operator consoles 110. Each operator console 110 could be used to provide information to an operator and receive information from an operator. For example, each operator console 110 could provide information identifying a current state of an industrial process to the operator, such as values of various process variables and warnings, alarms, or other states associated with the industrial process. Each operator console 110 could also receive information affecting how the industrial process is controlled, such as by receiving setpoints or control modes for process variables controlled by the controllers 106 or other information that alters or affects how the controllers 106 control the industrial process. Each operator console 110 includes any suitable structure for displaying information to and interacting with an operator. For example, each operator console 110 could represent a computing device running a WINDOWS operating system or other operating system. Multiple operator consoles 110 can be grouped together and used in one or more control rooms 112. Each control room 112 could include any number of operator consoles 110 in any suitable arrangement. In some embodiments, multiple control rooms 112 can be used to control, for instance, the facility like an industrial plant, such as when each control room 112 contains operator consoles 110 used to manage a discrete part of the industrial plant.

The process control system 100 here may optionally include at least one historian 114 and/or one or more servers 116. The historian 114 represents a component that stores various information about the process control system 100. The historian 114 could, for instance, store information that is generated by the various controllers 106 during the control of one or more industrial processes. The historian 114 includes any suitable structure for storing and facilitating retrieval of information. Although shown as a single component here, the historian 114 could be located elsewhere in the process control system 100, or multiple historians could be distributed in different locations in the process control system 100.

Each server 116 denotes a computing device that executes applications for users of the operator consoles 110 or other applications. The applications could be used to support various functions for the operator consoles 110, the controllers 106, or other components of the process control system 100. Each server 116 could represent a computing device running a WINDOWS operating system or other operating system. Note that while shown as being local within the process control system 100, the functionality of the server 116 could be remote from the process control system 100. For instance, the functionality of the server 116 could be implemented in a computing cloud 118 or a remote server communicatively coupled to the process control system 100 via a gateway 120.

Although FIG. 1 illustrates one example of the process control system 100, various changes may be made to FIG. 1. For example, the process control system 100 could include any number of sensors, actuators, controllers, networks, operator consoles, control rooms, historians, servers, and other components. Also, the makeup and arrangement of the process control system 100 in FIG. 1 is for illustration only. Components could be added, omitted, combined, further subdivided, or placed in any other suitable configuration according to particular needs. As a particular example, the historian 114 may be implemented in the computing cloud 118. Further, particular functions have been described as being performed by particular components of the process control system 100. This is for illustration only. In addition, FIG. 1 illustrates one example operational environment and arrangement of the process control system 100. In general, process control systems are highly configurable and can be configured in any suitable manner according to particular needs.

FIG. 2 illustrates a schematic diagram showing an implementation of an exemplary device that may execute techniques, in accordance with one or more example embodiments described herein. In one or more example embodiments, the device 200 described herein may include a set of instructions that can be executed to cause the device 200 to perform any one or more of the methods or computer-based functions disclosed herein. The device 200 may operate as a standalone device or may be connected, e.g., using a network, to other computer systems or peripheral devices.

In a networked deployment, the device 200 may operate in the capacity of a server or as a client in a server-client user network environment, or as a peer computer system in a peer-to-peer (or distributed) network environment. The device 200 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the device 200 can be implemented using electronic devices that provide voice, video, or data communication. Further, while the device 200 is illustrated as a single system, the term “system” shall also be taken to include any collection of systems or sub-systems that individually or jointly execute a set, or multiple sets, of instructions to perform one or more computer functions.

As illustrated in FIG. 2, the device 200 may include a processor 202, e.g., a central processing unit (CPU), a graphics processing unit (GPU), or both. The processor 202 may be a component in a variety of systems. For example, the processor 202 may be part of a standard computer. The processor 202 may be one or more general processors, digital signal processors, application specific integrated circuits, field programmable gate arrays, servers, networks, digital circuits, analog circuits, combinations thereof, or other now known or later developed devices for analyzing and processing data. The processor 202 may implement a software program, such as code generated manually (i.e., programmed).

The device 200 may include a memory 204 that can communicate via a bus 218. The memory 204 may be a main memory, a static memory, or a dynamic memory. The memory 204 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 204 includes a cache or random-access memory for the processor 202. In alternative implementations, the memory 204 is separate from the processor 202, such as a cache memory of a processor, the system memory, or other memory. The memory 204 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 204 is operable to store instructions executable by the processor 202. The functions, acts or tasks illustrated in the figures or described herein may be performed by the processor 202 executing the instructions stored in the memory 204. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing and the like.

As shown, the device 200 may further include a display 208, such as a liquid crystal display (LCD), an organic light emitting diode (OLED), a flat panel display, a solid-state display, a cathode ray tube (CRT), a projector, a printer or other now known or later developed display device for outputting determined information. The display 208 may act as an interface for the user to see the functioning of the processor 202, or specifically as an interface with the software stored in the memory 204 or in the drive unit 206. Additionally or alternatively, the device 200 may include an input/output device 210 configured to allow a user to interact with any of the components of the device 200. The input/output device 210 may be a number pad, a keyboard, or a cursor control device, such as a mouse, or a joystick, touch screen display, remote control, or any other device operative to interact with the device 200. The device 200 may also or alternatively include drive unit 206 implemented as a disk or optical drive. The drive unit 206 may include a computer-readable medium 220 in which one or more sets of instructions 216, e.g. software, can be embedded. Further, the instructions 216 may embody one or more of the methods or logic as described herein. The instructions 216 may reside completely or partially within the memory 204 and/or within the processor 202 during execution by the device 200. The memory 204 and the processor 202 also may include computer-readable media as discussed above.

In some systems, a computer-readable medium 220 includes instructions 216 or receives and executes instructions 216 responsive to a propagated signal so that a device connected to a network 214 can communicate voice, video, audio, images, or any other data over the network 214. Further, the instructions 216 may be transmitted or received over the network 214 via a communication port or interface 212, and/or using a bus 218. The communication port or interface 212 may be a part of the processor 202 or may be a separate component. The communication port or interface 212 may be created in software or may be a physical connection in hardware. The communication port or interface 212 may be configured to connect with a network 214, external media, the display 208, or any other components in the device 200, or combinations thereof. The connection with the network 214 may be a physical connection, such as a wired Ethernet connection or may be established wirelessly as discussed below. Likewise, the additional connections with other components of the device 200 may be physical connections or may be established wirelessly. The network 214 may alternatively be directly connected to a bus 218.

While the computer-readable medium 220 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 220 may be non-transitory, and may be tangible. The computer-readable medium 220 can include a solid-state memory such as a memory card or other package that houses one or more non-volatile read-only memories. The computer-readable medium 220 can be a random-access memory or other volatile re-writable memory. Additionally or alternatively, the computer-readable medium 220 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The device 200 may be connected to a network 214. The network 214 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 214 may include wide area networks (WAN), such as the Internet, local area networks (LAN), campus area networks, metropolitan area networks, a direct connection such as through a Universal Serial Bus (USB) port, or any other networks that may allow for data communication. The network 214 may be configured to couple one computing device to another computing device to enable communication of data between the devices. The network 214 may generally be enabled to employ any form of machine-readable media for communicating information from one device to another. The network 214 may include communication methods by which information may travel between computing devices. The network 214 may be divided into sub-networks. The sub-networks may allow access to all of the other components connected thereto or the sub-networks may restrict access between the components. The network 214 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations can include distributed processing, component/object distributed processing, and parallel processing. Alternatively, virtual computer system processing can be constructed to implement one or more of the methods or functionality as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof. It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

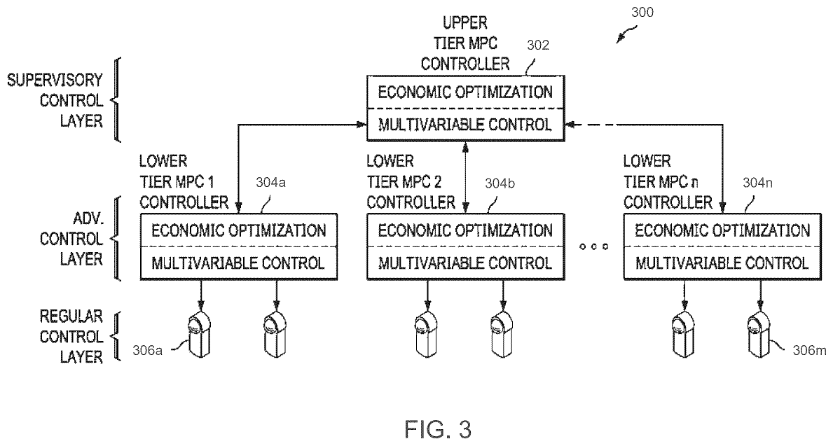

FIG. 3 illustrates a schematic diagram showing an implementation of an exemplary cascaded model predictive control (MPC) system for an exemplary process control system, in accordance with one or more example embodiments described herein. That is, FIG. 3 illustrates an example cascaded MPC system 300 for the process control system 100 shown in FIG. 1. As shown in FIG. 3, the cascaded MPC system 300 includes an upper tier MPC controller 302 and at least one, and generally two or more lower tier MPC controllers shown as 304a-304n. The lower tier MPC controllers 304a-304n interact with one or more regular process controllers 306a-306m, which are associated with one or more processes run within the facility. The lower tier MPC controllers 304a-304n generally denote the second set of controllers 106 as described in accordance with FIG. 1 of the current disclosure, while the process controllers 306a-306m generally denote the first set of controllers 106 as described in accordance with FIG. 1 of the current disclosure. Whereas the upper tier MPC controller 302 generally denotes the third set of controllers 106 described in accordance with FIG. 1 of the current disclosure. The process control system 100 in conjunction with the cascaded MPC system 300 drives one or more processes in the facility through variables such as manipulated variables (MV), monitors one or more process constraints through controlled variables (CV) and makes use of disturbance variables (DV) to improve predictions and take pre-emptive action to maintain the one or more processes within constraints.

The facility may also include sensors, actuators, and other lower-level components as described in FIG. 1 of the current disclosure. The upper tier MPC controller 302 generally operates within an upper tier control loop, while each lower tier MPC controllers 304a-304n generally operates within a lower tier control loop. There could be one or multiple lower tier control loops within a single upper tier control loop. Each MPC controller 302, 304a-304n supports business optimization and multivariable control functions. The upper tier MPC controller 302 uses planning models (such as multivariable models) to provide an initial steady-state gain matrix, and relevant model dynamics can be determined using operating data of the facility (such as historical data). The upper tier MPC controller 302 operates to control product inventories, manufacturing activities, or product qualities within the facility. The embedded business optimizer of the upper tier MPC controller 302, which is furnished with the same planning model structure and economics, can therefore reproduce the single-period offline planning optimization but in an online and real-time manner.

The upper tier MPC controller 302 is shown cascading on top of the lower tier MPC controllers 304a-304n (n is an integer value greater than or equal to one). Jointly, the MPC controller 302, and the lower tier MPC controllers 304a-304n provide simultaneously decentralized controls at lower tier (such as at the unit level) with fine-scale MPC models and centralized plantwide optimization at upper tiers (such as at the facility level) with a coarse-scale planning model, all in one consistent cascaded control system. Also, the upper tier MPC controller 302 is embedded with an optimizer (alternatively, referred to as plantwide optimizer) to deal with uncertainties, such as changes in feed quality or in ambient conditions, process unit upsets, heating or cooling capacity limitations, and maintenances in the facility. The optimizer may execute at a user-defined frequency, such as one ranging from once every several minutes to once an hour. Both production quantities and qualities of each unit may be measured or estimated at that frequency, and prediction errors may be bias corrected in the upper tier MPC controller 302 as in any standard MPC. If any deviations from an original optimal plan are detected, a plantwide re-optimization can take place immediately. The new optimal production targets can then be sent to and get carried out by the lower tier MPC controllers 304a-304n, reducing or eliminating the need for manual translation or adjustment.

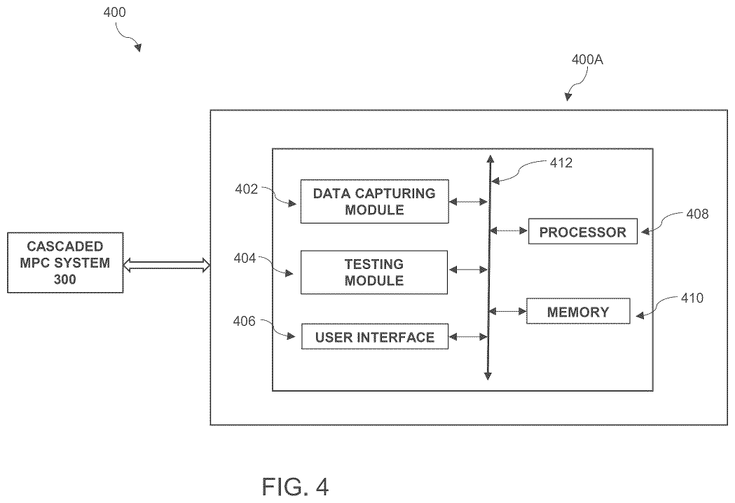

FIG. 4 illustrates a schematic diagram showing an implementation of an exemplary testing environment, in accordance with one or more example embodiments described herein. The exemplary testing environment 400 described herein comprises an exemplary testing system 400A communicatively coupled to the exemplary cascaded MPC system 300 (which is described in accordance with FIG. 3 of the current disclosure). In this regard, the exemplary testing system 400A may be communicatively coupled to the exemplary cascaded MPC system 300 through wireless communication (e.g., Wi-Fi, radio communication, etc.) and/or a wired data connection (e.g., a universal serial bus, an onboard diagnostic system, etc.) or other communication modes, such as a local area network (LAN), wide area network (WAN) such as the Internet, a telecommunications network, a data network, or any other type of network. The testing system 400A described herein facilitates offline testing of one or more Advanced Process Control (APC) strategies in the facility considering the overall process control system 100 along with the cascaded MPC system 300. Initially, the testing system 400A captures snapshots of a model predictive controller which is operating that is, under operation in the facility. Using the snapshots, the testing system 400A initializes a digital twin of a process unit (and/or of the facility). Then, the testing system 400A renders a tuning overlay via a user interface based on the initialization of the digital twin of the process unit (and/or of the facility). Such rendering facilitates a user associated with the facility (personnel such as operators and/or engineers) to provide inputs for respective fields in the tuning overlay. The inputs are associated with at least one APC strategy that is to be tested in the facility. Considering the inputs, the testing system 400A described herein tests the at least one APC strategy using the digital twin of the process unit (and/or of the facility). Based on the testing, the testing system 400A renders results for the at least one APC strategy. Also, based on the results, the testing system 400A modifies at least one operation of the process unit in the facility.

In some example embodiments, the testing system 400A is a server system (e.g., a server device) that facilitates a data analytics platform between one or more computing devices, one or more data sources, and/or one or more facilities. In some example embodiments, the testing system 400A is a device with one or more processors and a memory (such as the device 200 described in accordance with FIG. 2 of the current disclosure). Also, in some example embodiments, the testing system 400A is implementable via the cloud 118. The testing system 400A is implementable in one or more facilities related to one or more technologies, for example, but not limited to, enterprise technologies, connected building technologies, industrial technologies, Internet of Things (IoT) technologies, data analytics technologies, digital transformation technologies, cloud computing technologies, cloud database technologies, server technologies, network technologies, private enterprise network technologies, wireless communication technologies, machine learning technologies, artificial intelligence technologies, digital processing technologies, electronic device technologies, computer technologies, supply chain analytics technologies, aircraft technologies, industrial technologies, cybersecurity technologies, navigation technologies, asset visualization technologies, oil and gas technologies, petrochemical technologies, refinery technologies, life science technologies, process plant technologies, procurement technologies, and/or one or more other technologies.

In some example embodiments, the testing system 400A comprises one or more components such as, a data capturing module 402, a testing module 404, and/or a user interface 406. Additionally, in one or more example embodiments, the testing system 400A comprises a processor 408 and/or a memory 410. In one or more example embodiments, one or more components of the testing system 400A may be communicatively coupled to processor 408 and/or a memory 410 via a bus 412. In certain example embodiments, one or more aspects of the testing system 400A (and/or other systems, apparatuses and/or processes disclosed herein) constitute executable instructions embodied within a computer-readable storage medium (e.g., the memory 410). For instance, in an example embodiment, the memory 410 stores computer executable component and/or executable instructions (e.g., program instructions). Furthermore, the processor 408 facilitates execution of the computer executable components and/or the executable instructions (e.g., the program instructions). In an example embodiment, the processor 408 is configured to execute instructions stored in the memory 410 or otherwise accessible to the processor 408.

The processor 408 is a hardware entity (e.g., physically embodied in circuitry) capable of performing operations according to one or more embodiments of the disclosure. Alternatively, in an example embodiment where the processor 408 is embodied as an executor of software instructions, the software instructions configure the processor 408 to perform one or more algorithms and/or operations described herein in response to the software instructions being executed. In an example embodiment, the processor 408 is a single core processor, a multi-core processor, multiple processors internal to the testing system 400A, a remote processor (e.g., a processor implemented on a server), and/or a virtual machine. In certain example embodiments, the processor 408 is in communication with the memory 410, the data capturing module 402, the testing module 404, and/or the user interface 406 via the bus 412 to, for example, facilitate transmission of data between the processor 408, the memory 410, the data capturing module 402, the testing module 404, and/or the user interface 406. In some example embodiments, the processor 408 may be embodied in a number of different ways and, in certain example embodiments, includes one or more processing devices configured to perform independently. Additionally or alternatively, in one or more example embodiments, the processor 408 includes one or more processors configured in tandem via bus 412 to enable independent execution of instructions, pipelining of data, and/or multi-thread execution of instructions.

The memory 410 is non-transitory and includes, for example, one or more volatile memories and/or one or more non-volatile memories. In other words, in one or more example embodiments, the memory 410 is an electronic storage device (e.g., a computer-readable storage medium). The memory 410 is configured to store information, data, content, one or more applications, one or more instructions, or the like, to enable the testing system 400A to carry out various functions in accordance with one or more embodiments disclosed herein. In accordance with some example embodiments described herein, the memory 410 may correspond to an internal or external memory of the testing system 400A. In some examples, the memory 410 may correspond to a database communicatively coupled to the testing system 400A. As used herein in this disclosure, the term “component,” “system,” and the like, is a computer-related entity. For instance, “a component,” “a system,” and the like disclosed herein is either hardware, software, or a combination of hardware and software. As an example, a component is, but is not limited to, a process executed on a processor, a processor circuitry, an executable component, a thread of instructions, a program, and/or a computer entity.

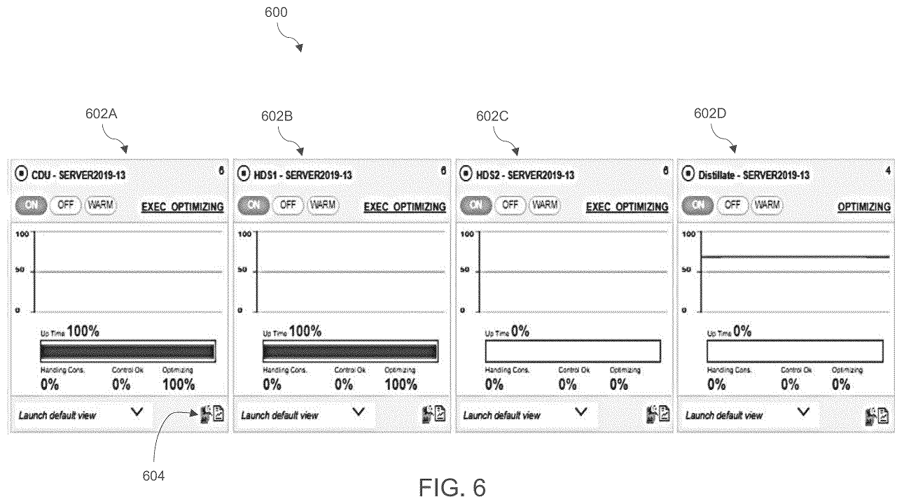

In one or more example embodiments, the data capturing module 402 captures one or more snapshots of a model predictive controller which is under operation (or live) in the facility. The model predictive controller described herein corresponds to the upper tier MPC controller 302 (alternatively, referred to as plantwide optimizer) or one of the lower tier MPC controllers 304a-304n as described in FIG. 3 of the current disclosure. As described in accordance with FIG. 1 and FIG. 3 of the current disclosure, the model predictive controller is configured to manage a set of assets such as process units (or equipment) along with associated processes handled by the set of assets in the facility. Per this aspect, the facility often incorporates several such model predictive controllers to manage (that is, control and optimize) substantial number of assets and processes handled by such assets in the facility. For instance, the model predictive controller described herein may control and optimize utilization of a process unit such as a blender in the facility which is associated with blending operations in the facility. Further, the data capturing module 402 captures the one or more snapshots of the model predictive controller based on a selection received from the user via the user interface 406. More particularly, the data capturing module 402 renders via the user interface 406, an option corresponding to capture the one or more snapshots of the model predictive controller. So, in response to rendering such option, the user may select the option via the user interface 406. Then, the data capturing module 402 automatically captures the one or more snapshots of the live operating model predictive controller based on the selection of the option received via the user interface 406. Also, an exemplary user interface rendering the said option is described in accordance with FIG. 6 of the current disclosure as well. It is to be noted that the data capturing module 402 may also capture snapshots of more than one model predictive controller as well in some embodiments described herein. For example, the data capturing module 402 may capture a first set of snapshots of a first model predictive controller controlling a furnace along with a second set of snapshots of a second model predictive controller controlling a batch blender.

Upon capturing the one or more snapshots of the live operating model predictive controller, in one or more example embodiments described herein, the testing module 404 initializes a digital twin of the process unit. In this regard, the testing module 404 initially loads the one or more snapshots into the digital twin of the process unit. Then, the testing module 404 derives details related to the process unit from the one or more snapshots. Per this aspect, the details comprise one or more current operating conditions of the process unit and one or more APC checkpoints for the process unit. It is to be noted that the details are often derived based on the processing of the one or more snapshots by the testing module 404. Further, the testing module 404 creates one or more initial conditions for the digital twin of the process unit using the derived details. Per this aspect, the testing module 404 allows initialization of digital twins in an offline environment considering the details of live model predictive controllers in the facility. It is to be noted that the testing module 404 may consider snapshots of multiple model predictive controllers which are operating in the facility and may initialize digital twins of respective process units in the facility. For example, the data capturing module 402 may capture a first set of snapshots of a first model predictive controller controlling a furnace to initialize a digital twin of the furnace along with a second set of snapshots of a second model predictive controller controlling a batch blender to initialize a digital twin of the batch blender. Also, it is to be appreciated that in some embodiments, the testing module 404 additionally or alternatively initializes a digital twin of the facility along with initializing digital twin(s) of process unit(s) in the facility using relevant snapshots as well.

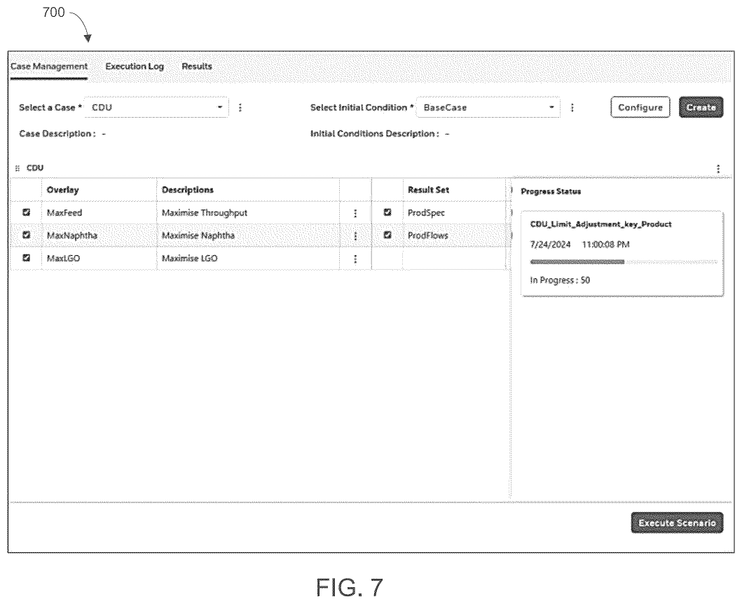

Then, in one or more example embodiments, the testing module 404 renders the tuning overlay via the user interface 406. The tuning overlay displayed via the user interface 406 comprises one or more fields which are tunable or adjustable by the user associated with the facility based on the at least one APC strategy that is to be tested in the facility. The one or more fields included in the tuning overlay are often based on the details derived from the one or more snapshots. That is, considering the details derived from the one or more snapshots, the testing module 404 at times determines the one or more fields to be included in the tuning overlay. Generally, the one or more fields relate to case selection for at least one process unit, initial condition for at least one process unit, one or more process parameters associated with at least one of: a process unit and the facility. More particularly, the testing module 404 may determine specific fields which is to be included in the tuning overlay considering the one or more current operating conditions of the process unit and the one or more APC checkpoints for the process unit. For example, details derived for a blender in the facility may comprise a current feed rate, a type of raw material being fed, and a current operating state of the blender. The testing module 404 may consider these details for the blender and may determine range of feed rate, different raw materials that may be fed to the blender, and possible operating states for the blender as fields to be included in the tuning overlay. Also, an exemplary user interface rendering an example tuning overlay is described in accordance with FIG. 7 of the current disclosure as well.

Further, in one or more example embodiments described herein, the testing system 400A allows the user to provide one or more inputs via the user interface 406 upon rendering the tuning overlay. Per this aspect, the testing module 404 receives the one or more inputs from the user via the user interface 406 for the one or more fields in the tuning overlay. The one or more inputs are associated with the at least one APC strategy that is to be tested for the process unit and/or the facility. It is to be noted that the one or more inputs may be received as visual input(s), auditory input(s), and/or tactile input(s) at the testing system 400A. The one or more inputs are often received as one or more selections and/or one or more values entered by the user via the user interface 406 related to the at least one APC strategy that is to be tested. For example, the user may provide an input corresponding to a selection of a case in the tuning overlay while another input may correspond to a value entered for feed rate in the tuning overlay. Also, some inputs received from the user in the tuning overlay correspond to modifications in certain current operating conditions and/or few APC checkpoints for process unit(s) in the tuning overlay. With this, the user provides desired inputs to test the at least one APC strategy using the testing system 400A described herein. The at least one APC strategy described herein comprises one or more of: change in operating states driven by market conditions, process conditions, environmental conditions, and/or conditions in the facility, economic changes based on change in pricing and/or availability of raw materials, economic changes due to change in one or more product pricings, economic changes due to change in demand, economic changes due to change in availability of one or more utilities, economic changes due to change in cost of the one or more utilities, benefit estimation of implementation of a specific process in the facility, or testing, commissioning and troubleshooting of one or more operational issues in the facility. For example, a strategy corresponding to economic changes based on change in raw material costs corresponds to studying effects of change in feed stock prices and comparison of effects of change in spot crude prices versus long term crude prices. In another example, a strategy corresponding to economic changes based on change in product pricing corresponds to studying effects of change in product selling prices based on current market prices versus forecasted product prices. Further, in another example, a strategy corresponding to economic changes based on change in utility prices corresponds to studying effects of change in electricity prices based on current market prices versus forecasted utility prices. Furthermore, in another example, a strategy corresponding to implementation of a specific process in the facility includes understanding effects of seasonal changes which affect cooling capacity due to operation of various assets and/or processes undertaken in the facility. Yet other examples of a strategy correspond to understanding a scenario where surplus water is processed versus a scenario where there is water scarcity, understanding a market where ethane gas is extracted via natural gas processing plant versus re-injecting gas into gas production wells depending on market demand, or understanding an impact on operating state of the facility based on change in availability of raw materials such as availability of heavy crude versus availability of normal crude.

Then, in one or more example embodiments described herein, the testing module 404 tests the at least one APC strategy based on the one or more inputs using the digital twin of the process unit. That is, the testing module 404 tests the at least one APC strategy in light of the said inputs using the initialized digital twin of the process unit. The at least one APC strategy tested facilitates the user to perform “what-if” analysis for various conditions related to process unit(s) and/or the facility which the user desires. That is, the APC strategies described herein facilitate the user to study effects of various conditions related to process unit(s) and/or the facility. For example, to test a strategy corresponding to understanding economic changes based on change in utility prices, the user may provide inputs such as selecting electricity as a specific utility which the user desires to understand change in electricity prices based on current market prices versus forecasted utility prices. Based on such inputs, the testing module 404 tests the strategy corresponding to understanding economic changes based on change in utility prices using appropriate initialized digital twin(s) in an offline environment. It is to be noted that the testing module 404 described herein facilitates testing of the at least one APC strategy in an offline environment. In this regard, the testing module 404 breaks all communications to distributed control system (DCS)/programmable logic controller (PLC) of the process control system 100 for offline testing of the at least one APC strategy. This is to ensure that strategies tested do not hamper live operations of the assets and/or the processes in the facility. This also mitigates risks associated with writing out scenario in the facility which is operational or live. Also, it is to be appreciated that in some embodiments, the testing module 404 additionally or alternatively tests the at least one APC strategy based on the one or more inputs using an initialized digital twin of the facility along with initialized digital twin(s) of process unit(s) in the facility.

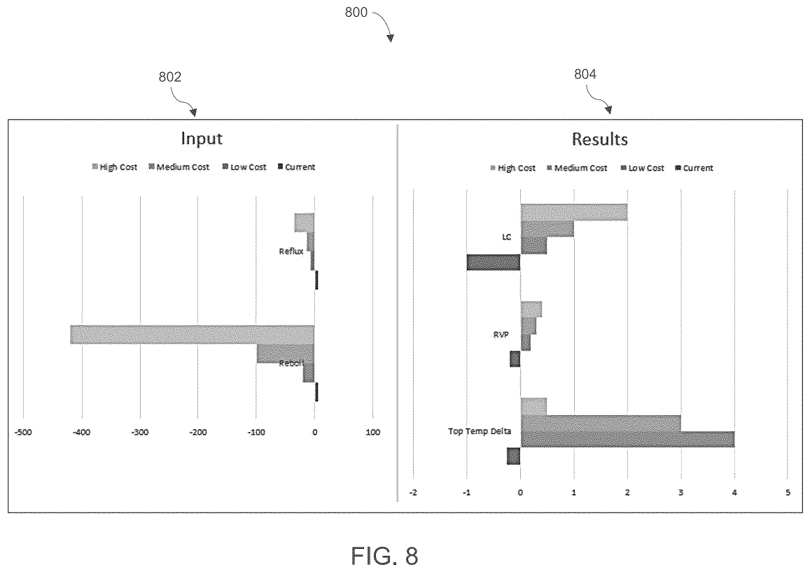

Upon testing the at least one APC strategy, in one or more example embodiments described herein, the testing module 404 renders one or more results for the at least one APC strategy via the user interface 406. The one or more results comprise information desired by the user or as expected by the user for the at least one APC strategy that is tested. Generally, the one or more results often comprise one or more differences between a current strategy that is followed in the facility and the at least one strategy that is tested, one or more corrective actions that may be implemented in the facility, one or more significant opportunities that may be utilized in the facility, and one or more predictions related to the assets and/or the processes in the facility. It is to be noted that at least some results may be presented using one or more graphical representations. Also, the testing module 404 described herein may render via the user interface 406, the one or more inputs provided by the user as graphical representations along with the one or more results as well. It is also to be noted that the testing system 400A may also store the one or more results obtained in response to testing each of such APC strategies. Additionally, the testing module 404 via the user interface 406 also allows the user to view and compare results from different APC strategies as well. Also, an exemplary user interface rendering exemplary results for an APC strategy is described in accordance with FIG. 8 of the current disclosure as well.

Additionally, in one or more example embodiments, the testing module 404 modifies the at least one operation of the process unit based at least on the one or more results. More particularly, the testing module 404 modifies the at least one operation of the process unit based at least on differences between strategies, corrective actions, significant opportunities, and/or predictions related to the assets and/or the processes in the facility. The modification to the at least one operation of the process unit for instance, may correspond to modifying an operating point for the process unit, pushing a process handled by the process unit to an optimal point, and/or the like. It is to be noted that the testing module 404 may automatically modify the at least one operation of the process unit in some example embodiments. Whereas the testing module 404 may modify the at least one operation of the process unit based on one or more additional inputs from the user in some other example embodiments. The one or more additional inputs may comprise feedback regarding the one or more results and/or one or more user suggested operational changes. It is to be noted that the one or more additional inputs may be received at the testing system 400A via the user interface 406. Also, the testing module 404 described herein may create one or more service cases in view of the one or more results. For instance, the testing module 404 may create one or more service cases in view of the one or more corrective actions that may be implemented in the facility and/or the one or more predictions so that appropriate personnel may undertake required steps or actions in the facility.

Accordingly, the testing environment 400 described herein facilitates automatic initialization of digital twin(s) using snapshots of live controller thereby reducing significant time and efforts of users or personnel in the facility. This also mitigates significant errors that may be caused due to manual work from personnel. Also, the testing environment 400 eliminates risks associated with writing out scenario in the facility as the testing system 400A enables testing of various scenarios in an offline platform. The results from testing of various strategies enables strategic planners and engineers associated with the facility to look into the future, by taking a current view of the process unit (and/or the facility) and superimposing likely scenarios on top of this. This will assist in making strategic decisions for managing the assets and/or the processes in the facility at lower operational costs and increased productivity. Additionally, the testing environment 400 facilitates development of an overall robust control system that facilitates better performance and reduced maintenance efforts in the facility.

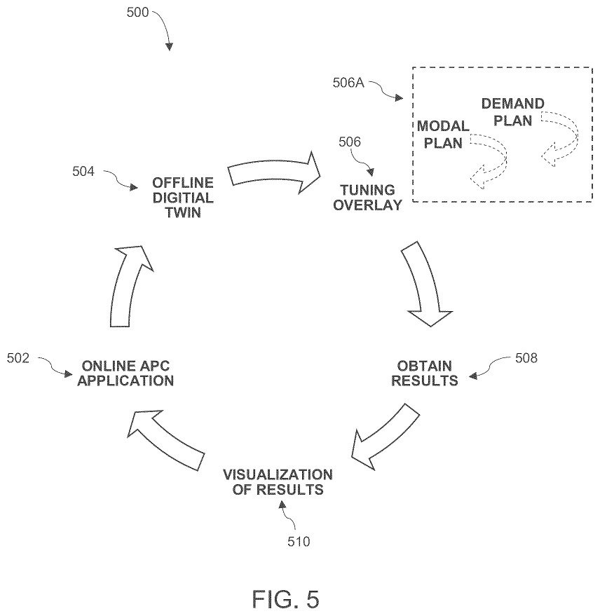

FIG. 5 illustrates a schematic diagram showing a specific implementation of an exemplary process associated with an exemplary testing environment, in accordance with one or more example embodiments described herein. In one or more example embodiments, the exemplary process 500 described herein illustrates steps or operations that are performable using the testing environment 400 which is described in accordance with FIG. 4 of the current disclosure. That is, the exemplary process 500 described herein illustrates steps or operations that facilitate a user to test at least one APC strategy using the testing environment 400. At step 502 of the process 500, one or more APC applications may be operating in the facility that is, the one or more APC applications may be online or live in the facility. In this regard, the one or more online APC applications may correspond to those applications used by the process control system 100 to control operations of assets and/or to optimize processes in the facility. The one or more online APC applications may comprise advanced algorithms and/or models executable by the controllers 106 that facilitate the process control system 100 to control operations of assets and/or to optimize processes in the facility. While the one or more APC applications are under operation, one or more snapshots of the controllers 106 may be captured in a manner as described in accordance with FIG. 4 of the current disclosure. At step 504 of the process 500, an offline digital twin of the facility may be initialized using the one or more snapshots of the controller(s) 106 in a manner as described in accordance with FIG. 4 of the current disclosure. Whereas at step 506 of the process 500, a tuning overlay is rendered to the user via the user interface 406 as described in accordance with FIG. 4 of the current disclosure. Additionally or alternatively, at step 506A of the process 500, a modal plan and/or a demand plan is also rendered via the user interface 406 along with the tuning overlay. This facilitates the user to provide certain inputs (in addition to providing the one or more inputs in the tuning overlay as described in accordance with FIG. 4 of the current disclosure) to the modal plan and/or the demand plan as well in view of the at least one APC strategy that is to be tested in the facility. So, considering such inputs, the at least one strategy is tested using the initialized digital twin of the facility in a manner as described in accordance with FIG. 4 of the current disclosure. Upon testing the at least one strategy, at step 508 of the process 500, the one or more results are obtained as described in accordance with FIG. 4 of the current disclosure. Further, at step 510 of the process 500, the one or more results are rendered (for instance, visualized) via the user interface 406 in a manner as described in accordance with FIG. 4 of the current disclosure.

FIG. 6 illustrates a schematic diagram showing an exemplary user interface associated with an exemplary testing environment, in accordance with one or more example embodiments described herein. The exemplary user interface 600 described herein comprises a dashboard rendering relevant particulars related to various assets associated with the facility. The user interface 600 illustrated comprises exemplary sections 602A, 602B, 602C, and 602D that display particulars associated with respective assets in the facility. For example, section 602A may be associated with a first asset controlled by a first model predictive controller in the facility. Similarly, section 602B may be associated with a second asset controlled by a second model predictive controller in the facility. While section 602C may be associated with a third asset controlled by a third model predictive controller in the facility. Yet section 602D may be associated with a fourth asset controlled by a fourth model predictive controller in the facility. The section 602A in the user interface 600 described herein comprises an option 604 that allows a user associated with the facility to capture one or more snapshots of the first model predictive controller. That is, the user interface 600 allows the user to select this option 604 in order to automatically capture the one or more snapshots of the first model predictive controller. It is to be noted that the selection of the option may be received as visual selection, audio-based selection, and/or tactile selection. As illustrated, each of the sections 602B-602D also comprise the said option that allows the user to capture snapshots of a respective model predictive controller as well. In response to receiving such selection, the data capturing module 402 captures relevant snapshots of a particular model predictive controller as described in accordance with FIG. 4 of the current disclosure.

FIG. 7 illustrates a schematic diagram showing an exemplary user interface associated with an exemplary testing environment, in accordance with one or more example embodiments described herein. The exemplary user interface 700 described herein comprises an exemplary tuning overlay as described in accordance with FIG. 4 of the current disclosure. As illustrated, the tuning overlay comprises a field relating to case selection for a process unit and another field relating to initial condition selection. The user may provide appropriate inputs at these fields and then provide another input at fields corresponding to configure or create. Then, the user may also provide appropriate inputs such as selections and/or values under fields of overlay, descriptions, and/or result set. Also, the tuning overlay comprises a field of execute scenario that allows the user to select and then test the at least one APC strategy based on the provided inputs. The tuning overlay also allows the user to view progress status related to the testing of the at least one APC strategy as well.

FIG. 8 illustrates a schematic diagram showing an exemplary user interface associated with an exemplary testing environment, in accordance with one or more example embodiments described herein. The exemplary user interface 800 described herein comprises exemplary results for an APC strategy that is tested in the facility using the testing environment 400. The user interface 800 comprises a first graphical representation 802 representing the one or more inputs provided by the user along with a second graphical representation 804 representing the one or more results obtained in response to testing the APC strategy. Such a representation allows the user to view and compare the provided inputs with the obtained results. The graphical representations 802 and 804 are exemplary only, and the inputs and/or the results may be illustrated in any other format as well.

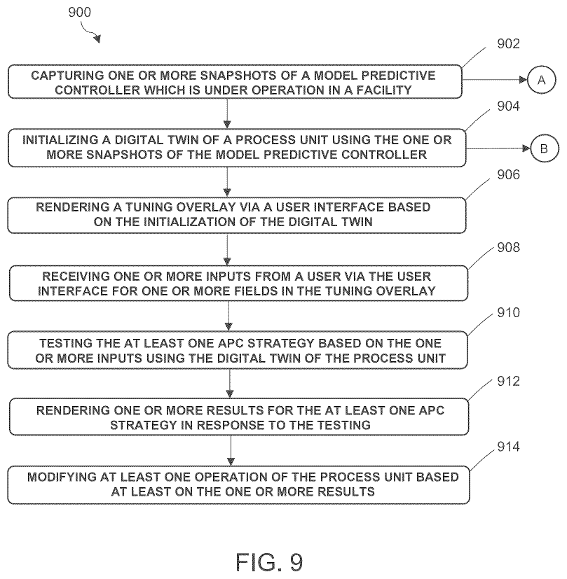

FIG. 9 illustrates a flowchart showing a method described in accordance with one or more example embodiments described herein. In this regard, FIG. 9 illustrates operations that may be performed using the testing environment 400. In some embodiments, the example method 900 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 900. At step 902 of the exemplary flowchart 900, the testing environment 400 comprises means such as, the data capturing module 402 to capture one or more snapshots of a model predictive controller which is under operation in a facility. Then, at step 904 of the exemplary flowchart 900, the testing environment 400 comprises means such as, the testing module 404 to initialize a digital twin of a process unit using the one or more snapshots of the model predictive controller. At step 906 of the exemplary flowchart 900, the testing environment 400 comprises means such as, the testing module 404 and the user interface 406 to render a tuning overlay based on the initialization of the digital twin. At step 908 of the exemplary flowchart 900, the testing environment 400 comprises means such as, the testing module 404 and the user interface 406 to receive one or more inputs from a user for one or more fields in the tuning overlay. At step 910 of the exemplary flowchart 900, the testing environment 400 comprises means such as, the testing module 404 to test the at least one APC strategy based on the one or more inputs using the digital twin of the process unit. At step 912 of the exemplary flowchart 900, the testing environment 400 comprises means such as, the testing module 404 and the user interface 406 to render one or more results for the at least one APC strategy in response to the testing. At step 914 of the exemplary flowchart 900, the testing environment 400 comprises means such as, the testing module 404 to modify at least one operation of the process unit based at least on the one or more results.

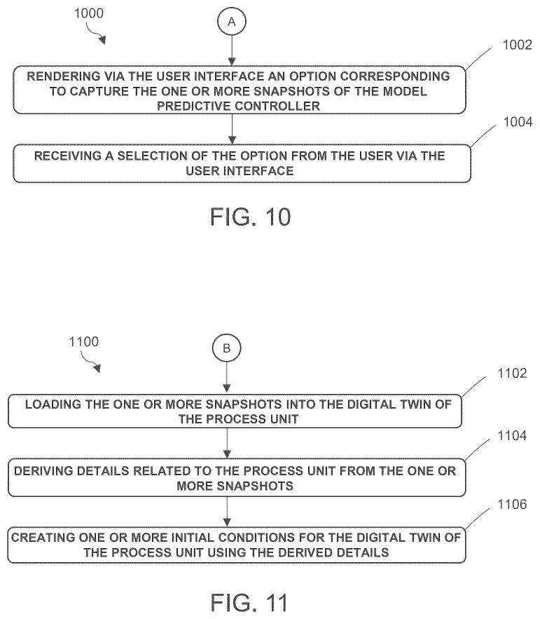

FIG. 10 illustrates a flowchart showing a method described in accordance with one or more example embodiments described herein. In this regard, FIG. 10 illustrates operations that may be performed using the testing environment 400. In some embodiments, the example method 1000 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 1000. At step 1002 of the exemplary flowchart 1000, the testing environment 400 comprises means such as, the data capturing module 402 and the user interface 406 to render an option corresponding to capture the one or more snapshots of the model predictive controller. At step 1004 of the exemplary flowchart 1000, the testing environment 400 comprises means such as, the data capturing module 402 and the user interface 406 to receive a selection of the option from the user.

FIG. 11 illustrates a flowchart showing a method described in accordance with one or more example embodiments described herein. In this regard, FIG. 11 illustrates operations that may be performed using the testing environment 400. In some embodiments, the example method 1100 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 1100. At step 1102 of the exemplary flowchart 1100, the testing environment 400 comprises means such as, the testing module 404 to load the one or more snapshots into the digital twin of the process unit. At step 1104 of the exemplary flowchart 1100, the testing environment 400 comprises means such as, the testing module 404 to derive details related to the process unit from the one or more snapshots. At step 1106 of the exemplary flowchart 1100, the testing environment 400 comprises means such as, the testing module 404 to create one or more initial conditions for the digital twin of the process unit using the derived details.

The foregoing embodiments are provided merely as illustrative examples and are not intended to require or imply that the steps of the various embodiments must be performed in the order presented. As will be appreciated by one of skill in the art the order of steps in the foregoing embodiments can be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

It is to be appreciated that ‘one or more’ includes a function being performed by one element, a function being performed by more than one element, e.g., in a distributed fashion, several functions being performed by one element, several functions being performed by several elements, or any combination of the above.

Moreover, it will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The systems, apparatuses, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context.

The hardware used to implement the various illustrative logics, logical blocks, modules, and circuits described in connection with the aspects disclosed herein can include a general purpose processor, a digital signal processor (DSP), a special-purpose processor such as an application specific integrated circuit (ASIC) or a field programmable gate array (FPGA), a programmable logic device, discrete gate or transistor logic, discrete hardware components, or any combination thereof designed to perform the functions described herein. A general-purpose processor can be a microprocessor, but, in the alternative, the processor can be any processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. Alternatively, or in addition, some steps or methods can be performed by circuitry that is specific to a given function.

In one or more example embodiments, the functions described herein can be implemented by special-purpose hardware or a combination of hardware programmed by firmware or other software. In implementations relying on firmware or other software, the functions can be performed as a result of execution of one or more instructions stored on one or more non-transitory computer-readable media and/or one or more non-transitory processor-readable media. These instructions can be embodied by one or more processor-executable software modules that reside on the one or more non-transitory computer-readable or processor-readable storage media. Non-transitory computer-readable or processor-readable storage media can in this regard comprise any storage media that can be accessed by a computer or a processor. By way of example but not limitation, such non-transitory computer-readable or processor-readable media can include random access memory (RAM), read-only memory (ROM), electrically erasable programmable read-only memory (EEPROM), FLASH memory, disk storage, magnetic storage devices, or the like. Disk storage, as used herein, includes compact disc (CD), laser disc, optical disc, digital versatile disc (DVD), floppy disk, and Blu-ray disc™, or other storage devices that store data magnetically or optically with lasers. Combinations of the above types of media are also included within the scope of the terms non-transitory computer-readable and processor-readable media. Additionally, any combination of instructions stored on the one or more non-transitory processor-readable or computer-readable media can be referred to herein as a computer program product.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components can be used in conjunction with the supply management system. Therefore, it is to be understood that the inventions are not to be limited to the specific embodiments disclosed and that modifications and other embodiments are intended to be included within the scope of the appended claims. Moreover, the steps in the method described above can not necessarily occur in the order depicted in the accompanying diagrams, and in some cases one or more of the steps depicted can occur substantially simultaneously, or additional steps can be involved. Although specific terms are employed herein, they are used in a generic and descriptive sense only and not for purposes of limitation. It is intended that the specification and examples be considered as exemplary only, with a true scope and spirit of the disclosure being indicated by the following claims.

1. A method for testing one or more Advanced Process Control (APC) strategies in a facility, the method comprising:
capturing one or more snapshots of a model predictive controller which is under operation in the facility;
initializing a digital twin of a process unit using the one or more snapshots of the model predictive controller;
rendering a tuning overlay via a user interface based on the initialization of the digital twin;
receiving one or more inputs from a user via the user interface for one or more fields in the tuning overlay, wherein the one or more inputs are associated with at least one APC strategy that is to be tested for the process unit;
testing the at least one APC strategy based on the one or more inputs using the digital twin of the process unit;
rendering one or more results for the at least one APC strategy in response to the testing; and
modifying at least one operation of the process unit based at least on the one or more results.

2. The method of claim 1, wherein capturing the one or more snapshots of the model predictive controller comprises:
rendering via the user interface an option corresponding to capture the one or more snapshots of the model predictive controller; and
receiving a selection of the option from the user via the user interface.

3. The method of claim 1, wherein initializing the digital twin of the process unit comprises:
loading the one or more snapshots into the digital twin of the process unit;
deriving details related to the process unit from the one or more snapshots, wherein the details comprise one or more current operating conditions of the process unit and one or more APC checkpoints for the process unit; and
creating one or more initial conditions for the digital twin of the process unit using the derived details.

4. The method of claim 3, wherein rendering the tuning overlay via the user interface comprises rendering the one or more fields in the tuning overlay based on the derived details, wherein the one or more fields relate to case selection for the process unit, initial condition for the process unit, one or more process parameters associated with at least one of the process unit and the facility.

5. The method of claim 1, wherein receiving the one or more inputs from the user comprises receiving one or more selections and one or more values entered by the user via the user interface related to the at least one APC strategy, wherein the at least one APC strategy comprises: change in operating states driven by one or more of: market conditions, process conditions, environmental conditions, and conditions in the facility, economic changes based on one or more of: change in pricing and availability of raw materials, economic changes due to change in one or more product pricings, economic changes due to change in demand, economic changes due to change in availability of one or more utilities, economic changes due to change in cost of the one or more utilities, benefit estimation of implementation of a specific process in the facility, or testing, commissioning and troubleshooting of one or more operational issues in the facility.

6. The method of claim 1, wherein rendering the one or more results for the at least one APC strategy comprises rendering at least some of the one or more results as one or more graphical representations, and wherein the one or more results comprise one or more differences between a current strategy that is followed in the facility and the at least one strategy that is tested, one or more corrective actions implementable in the facility, one or more significant opportunities for the facility, and one or more predictions related to the facility.

7. The method of claim 1, further comprising creating one or more service cases for the process unit based on the one or more results.

8. A system for extracting data from one or more documents associated with one or more assets in a facility, the system comprising:
a processor;
a memory communicatively coupled to the processor, wherein the memory comprises one or more instructions which when executed by the processor, cause the processor to:
capture one or more snapshots of a model predictive controller which is under operation in the facility;
initialize a digital twin of a process unit using the one or more snapshots of the model predictive controller;
render a tuning overlay via a user interface based on the initialization of the digital twin;
receive one or more inputs from a user via the user interface for one or more fields in the tuning overlay, wherein the one or more inputs are associated with at least one APC strategy that is to be tested for the process unit;
test the at least one APC strategy based on the one or more inputs using the digital twin of the process unit;
render one or more results for the at least one APC strategy in response to the testing; and
modify at least one operation of the process unit based at least on the one or more results.

9. The system of claim 8, wherein the processor is further configured to:
render via the user interface an option corresponding to capture the one or more snapshots of the model predictive controller; and
receive a selection of the option from the user via the user interface.

10. The system of claim 8, wherein the processor is further configured to:
load the one or more snapshots into the digital twin of the process unit;
derive details related to the process unit from the one or more snapshots, wherein the details comprise one or more current operating conditions of the process unit and one or more APC checkpoints for the process unit; and
create one or more initial conditions for the digital twin of the process unit using the derived details.

11. The system of claim 10, wherein the processor is further configured to render the one or more fields in the tuning overlay based on the derived details, wherein the one or more fields relate to case selection for the process unit, initial condition for the process unit, one or more process parameters associated with at least one of the process unit and the facility.

12. The system of claim 8, wherein the processor is further configured to receive one or more selections and one or more values entered by the user via the user interface related to the at least one APC strategy, wherein the at least one APC strategy comprises: change in operating states driven by one or more of: market conditions, process conditions, environmental conditions, and conditions in the facility, economic changes based on one or more of: change in pricing and availability of raw materials, economic changes due to change in one or more product pricings, economic changes due to change in demand, economic changes due to change in availability of one or more utilities, economic changes due to change in cost of the one or more utilities, benefit estimation of implementation of a specific process in the facility, or testing, commissioning and troubleshooting of one or more operational issues in the facility.

13. The system of claim 8, wherein the processor is further configured to render at least some of the one or more results as one or more graphical representations, and wherein the one or more results comprise one or more differences between a current strategy that is followed in the facility and the at least one strategy that is tested, one or more corrective actions implementable in the facility, one or more significant opportunities for the facility, and one or more predictions related to the facility.

14. The system of claim 8, wherein the processor is further configured to create one or more service cases for the process unit based on the one or more results.

15. A non-transitory, computer-readable storage medium having stored thereon executable instructions that, when executed by one or more processors, cause the one or more processors to:
capture one or more snapshots of a model predictive controller which is under operation in the facility;
initialize a digital twin of a process unit using the one or more snapshots of the model predictive controller;
render a tuning overlay via a user interface based on the initialization of the digital twin;
receive one or more inputs from a user via the user interface for one or more fields in the tuning overlay, wherein the one or more inputs are associated with at least one APC strategy that is to be tested for the process unit;
test the at least one APC strategy based on the one or more inputs using the digital twin of the process unit;
render one or more results for the at least one APC strategy in response to the testing; and
modify at least one operation of the process unit based at least on the one or more results.

16. The non-transitory, computer-readable storage medium of claim 15, wherein the one or more processors is further configured to:
render via the user interface an option corresponding to capture the one or more snapshots of the model predictive controller; and
receive a selection of the option from the user via the user interface.

17. The non-transitory, computer-readable storage medium of claim 15, wherein the one or more processors is further configured to:
load the one or more snapshots into the digital twin of the process unit;
derive details related to the process unit from the one or more snapshots, wherein the details comprise one or more current operating conditions of the process unit and one or more APC checkpoints for the process unit; and
create one or more initial conditions for the digital twin of the process unit using the derived details.

18. The non-transitory, computer-readable storage medium of claim 17, wherein the one or more processors is further configured to render the one or more fields in the tuning overlay based on the derived details, wherein the one or more fields relate to case selection for the process unit, initial condition for the process unit, one or more process parameters associated with at least one of the process unit and the facility.

19. The non-transitory, computer-readable storage medium of claim 15, wherein the one or more processors is further configured to receive one or more selections and one or more values entered by the user via the user interface related to the at least one APC strategy, wherein the at least one APC strategy comprises: change in operating states driven by one or more of: market conditions, process conditions, environmental conditions, and conditions in the facility, economic changes based on one or more of: change in pricing and availability of raw materials, economic changes due to change in one or more product pricings, economic changes due to change in demand, economic changes due to change in availability of one or more utilities, economic changes due to change in cost of the one or more utilities, benefit estimation of implementation of a specific process in the facility, or testing, commissioning and troubleshooting of one or more operational issues in the facility.

20. The non-transitory, computer-readable storage medium of claim 15, wherein the one or more processors is further configured to render at least some of the one or more results as one or more graphical representations, and wherein the one or more results comprise one or more differences between a current strategy that is followed in the facility and the at least one strategy that is tested, one or more corrective actions implementable in the facility, one or more significant opportunities for the facility, and one or more predictions related to the facility.
